(19) United States
(12) Patent Application Publication
(10) Pub. No.: US 2005/0198392 A1
(43) Pub. Date: Sep. 8, 2005

(54) Message monitoring method and apparatus involving SECS-to-XML message conversion for application to a semiconductor equipment system

(76) Inventors: Wen-Chen Yu, Taipei (TW); Kuo-Ping Chiang, Taipei (TW); Cheng-Hung Hsieh, Taipei (TW); Jiun-Yi Wang, Taipei (TW)

Correspondence Address: WHYTE HIRSCHBOECK DUDEK S C, 555 EAST WELLS STREET, SUITE 1900, MILWAUKEE, WI, 53202, US

(21) Appl. No.: 10/872,809

(22) Filed: Jun. 21, 2004

(30) Foreign Application Priority Data
Dec. 31, 2003 (TW) 092137680

(51) Int. Cl. G06F 15/16

(52) U.S. Cl. 709/246

(57) ABSTRACT

In a SECS-to-XML message converting method and apparatus, SECS messages transacted in a semiconductor equipment system are parsed into sets of SECS items that are subsequently coded. Coded SECS items of the SECS messages from a semiconductor equipment are paired with the coded SECS items of the SECS messages from a tool control unit and corresponding to preset items of interest SECS items corresponding to the preset items of interest according to the dependency thereof. The paired coded SECS items are then converted into XML messages.

### CROSS-REFERENCE TO RELATED APPLICATION

This application claims priority of Taiwanese Application No. 092137680, filed on Dec. 31, 2003.

### BACKGROUND OF THE INVENTION

1. Field of the Invention

The invention relates to the art of message conversion, more particularly to a message monitoring method and apparatus involving SECS-to-XML message conversion for application to a semiconductor equipment system.

2. Description of the Related Art

Advanced process control in semiconductor fabrication processes involves real-time feedback adjustment, and error detection and analysis. Real-time feedback adjustment is directed to real-time adjustment of process parameters in a multi-equipment fabrication process to reduce process variables and improve product yield. Error detection and analysis is directed to predicting abnormal status of equipments or products so as to help maintain normal operation of fabrication equipment.

At present, during advanced process control, GEM/SECS messages are transacted in a semiconductor equipment system. GEM/SECS is a specification language developed by the Semiconductor Equipment and Materials International (SEMI) trade association. SECS messages can be classified into SECS-I messages, which define patterns for transmission and reception, and SECS-II messages, which define how conveying of information between a semiconductor equipment and a tool control unit is realized.

SECS-II messages, which are also known as streams, are organized into primary messages and secondary messages. FIG. 1 illustrates an example of SECS-II message transaction between a tool control unit 101 and a semiconductor equipment 102. In this example, SECS messages 201, such as S1F3, S2F33 and S6F11, are primary messages whereas SECS messages 202, such as S1F4, S2F34 and S6F12, are secondary messages. More specifically, S1F3 is a request from the tool control unit 101 to the semiconductor equipment 102 to report equipment status data, such as SVID1-SVIDn values, and S1F4 is a reply corresponding to the request from the semiconductor equipment 101 to the tool control unit 101. Upon receipt of the secondary messages, the tool control unit 101 can under take the necessary actions for advanced process control.

However, since SECS language is a machine language, it is not possible for an operator to monitor operating status of the semiconductor equipment system by simply reading the SECS messages that are transacted therein.

### SUMMARY OF THE INVENTION

Therefore, the object of the present invention is to provide a message monitoring method and apparatus involving SECS-to-XML message conversion for application to a semiconductor equipment system.

According to a first aspect of the present invention, there is provided a method of monitoring message transactions in a semiconductor equipment system. The method comprises the steps of:
a) converting SECS messages, which are in a semiconductor equipment communications standard (SECS) language, transacted in the semiconductor equipment system into XML messages, which are in an extensible markup language (XML); and
b) generating a display window for visual indication of the XML messages.

According to a second aspect of the present invention, there is provided a method of converting SECS messages transacted between a tool control unit and a semiconductor equipment in a semiconductor equipment system into XML messages. Each of the SECS messages is in a semiconductor equipment communications standard (SECS) language. The XML messages are in an extensible markup language (XML). The method comprises the steps of:
a) parsing each of the SECS messages into a set of SECS items;
b) coding each of the SECS items of the SECS messages;
c) determining which ones of the coded SECS items of the SECS messages from the tool control unit correspond to preset items of interest;
d) determining which ones of the coded SECS items of the SECS messages from the semiconductor equipment have a dependency with any one of the coded SECS items determined in step c);
e) pairing the coded SECS items determined in step d) with the coded SECS items determined in step c) according to the dependency thereof; and
f) converting the paired coded SECS items obtained in step e) into the XML messages.

According to a third aspect of the present invention, there is provided an apparatus for monitoring message transactions in a semiconductor equipment system. The apparatus comprises:
converting means for converting SECS messages, which are in a semiconductor equipment communications standard (SECS) language, transacted in the semiconductor equipment system into XML messages, which are in an extensible markup language (XML); and
display generating means, coupled to the converting means, for generating a display window to provide a visual indication of the XML messages.

According to a fourth aspect of the present invention, there is provided an apparatus for converting SECS messages transacted between a tool control unit and a semiconductor equipment in a semiconductor equipment system into XML messages. Each of the SECS messages is in a semiconductor equipment communications standard (SECS) language. The XML messages are in an extensible markup language (XML). The apparatus comprises:
an interface processing unit adapted to be coupled to the tool control unit and the semiconductor equipment for receiving the SECS messages therefrom;
a register coupled to the interface processing unit for storing the SECS messages from the semiconductor equipment and the tool control unit and transmitted via the interface processing unit; and
a converting unit coupled to the register and including
   a parsing module for parsing each of the SECS messages stored in the register into a set of SECS items,
   a coding module for coding each of the SECS items of the SECS messages,
   a mapping module for mapping the SECS items of the SECS messages coded by the coding module, and
   a translating module for translating the coded SECS items mapped by the mapping module into the XML messages.

According to a fifth aspect of the present invention, there is provided a computer program product for configuring an apparatus to perform steps of a method of converting SECS messages transacted between a tool control unit and a semiconductor equipment in a semiconductor equipment system into XML messages. Each of the SECS messages is in a semiconductor equipment communications standard (SECS) language. The XML messages are in an extensible markup language (XML). The apparatus includes an interface processing unit coupled to the tool control unit and the semiconductor equipment for receiving the SECS message therefrom, a register coupled to the interface processing unit for storing the SECS messages from the semiconductor equipment and the tool control unit and transmitted via the interface processing unit, and a converting unit coupled to the register. The computer program product comprises:
a computer readable storage medium comprising:
   a first code that directs the converting unit to parse each of the SECS messages into a set of SECS items;
   a second code that directs the converting unit to code each of the SECS items of the SECS messages;
   a third code that directs the converting unit to determine which ones of the coded SECS items of the SECS messages from the tool control unit correspond to preset items of interest;
   a fourth code that directs the converting unit to determining which ones of the coded SECS items of the SECS messages from the semiconductor equipment have a dependency with any one of the coded SECS items corresponding to the preset items of interest;
   a fifth code that directs the converting unit to pair the coded SECS items of the SECS messages according to the dependency thereof; and
   a sixth code that directs the converting unit to convert the paired coded SECS items into the XML messages.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram illustrating conventional message transaction in a semiconductor equipment system;

FIG. 2 is a schematic circuit block diagram illustrating a message converting apparatus that is configured according to the preferred embodiment of a method of converting SECS messages transacted in a semiconductor equipment system into XML messages of the present invention;

FIG. 3 is a flow chart illustrating how the message converting apparatus converts SECS messages into XML messages in accordance with the method of the preferred embodiment;

FIG. 4 illustrates an example of message transaction in a semiconductor equipment system;

FIG. 5 illustrates an example of coding a SECS message;

FIG. 6 illustrates an example of paired SECS items according to the method of the preferred embodiment; and

FIG. 7 illustrates an example of converting a SECS message into an XML message.

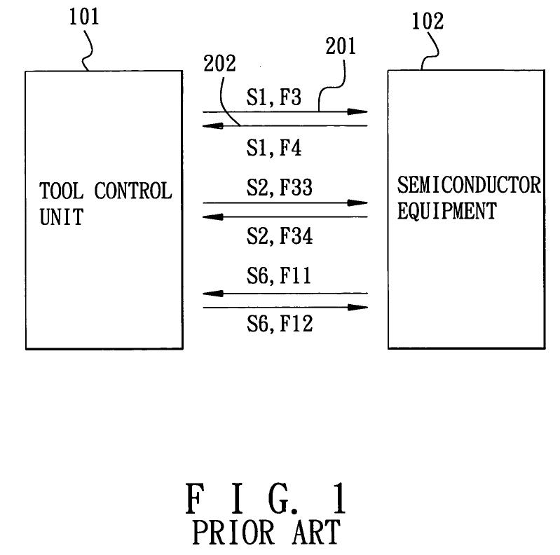

### DETAILED DESCRIPTION OF THE PREFERRED EMBODIMENT

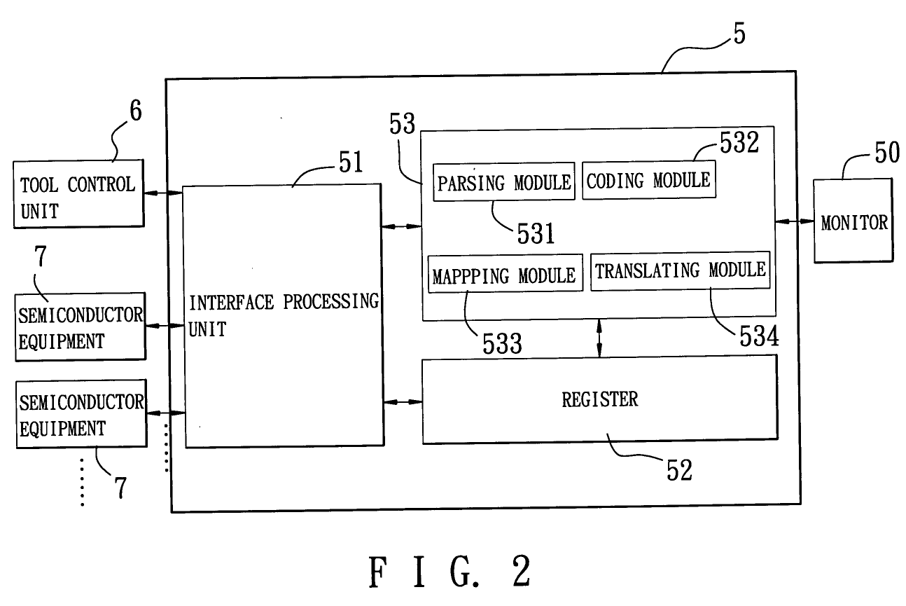

FIG. 2 illustrates a message converting apparatus 5 that is configured by a proprietary computer program product to perform steps of the preferred embodiment of a method of converting SECS messages transacted among a tool control unit 6 and a plurality of semiconductor equipments 7 in a semiconductor equipment system into XML messages according to the present invention. Each of the SECS messages is in a semiconductor equipment communications standard (SECS) language. As is known in the art, there exists a message transfer protocol which is used to send messages among the tool control unit 6 and the semiconductor equipments 7. The message transfer protocol must be capable of sending a primary message, indicating whether a reply is requested; and if a reply is requested, it must be capable of associating the corresponding secondary message or reply message with the original primary message. The messages being transferred under the protocol is in the form of SECS messages. In this embodiment, the SECS messages are SECS-II messages. The XML messages are in an extensible markup language (XML). It is noted that XML is a text-based markup language which uses tags, elements and attributes such that XML can be used to define data structures and process information. The message converting apparatus 5 includes an interface processing unit 51, a register 52, and a converting unit 53. The interface processing unit 51 is adapted to be coupled to the tool control unit 6 and the semiconductor equipments 7 for receiving the SECS messages therefrom. In this embodiment, the interface processing unit 51 includes an RS232 or a TCP/IP interface.

The register 52 is coupled to the interface processing unit 51 for storing the SECS messages from the semiconductor equipments 7 and the tool control unit 6 and transmitted via the interface processing unit 51.

The converting unit 53 is coupled to the register 52, and includes a parsing module 531, a coding module 532, a mapping module 533 and a translating module 534.

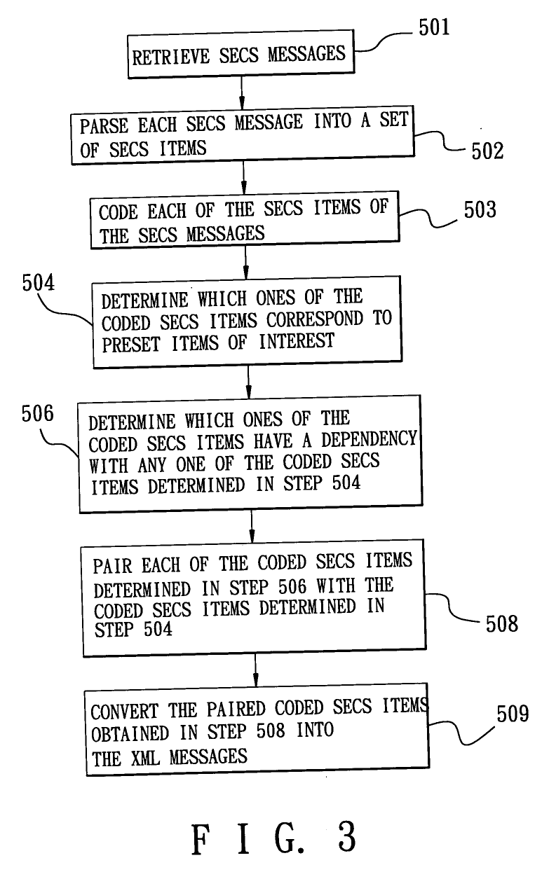

Referring to FIG. 3, there is shown a flow chart illustrating how the message converting apparatus 5 converts SECS messages into XML messages in accordance with the method of the preferred embodiment.

In step 501, the converting unit 53 retrieves the SECS messages stored in the register 52.

In step 502, the parsing module 531 parses each of the SECS messages into a set of SECS items.

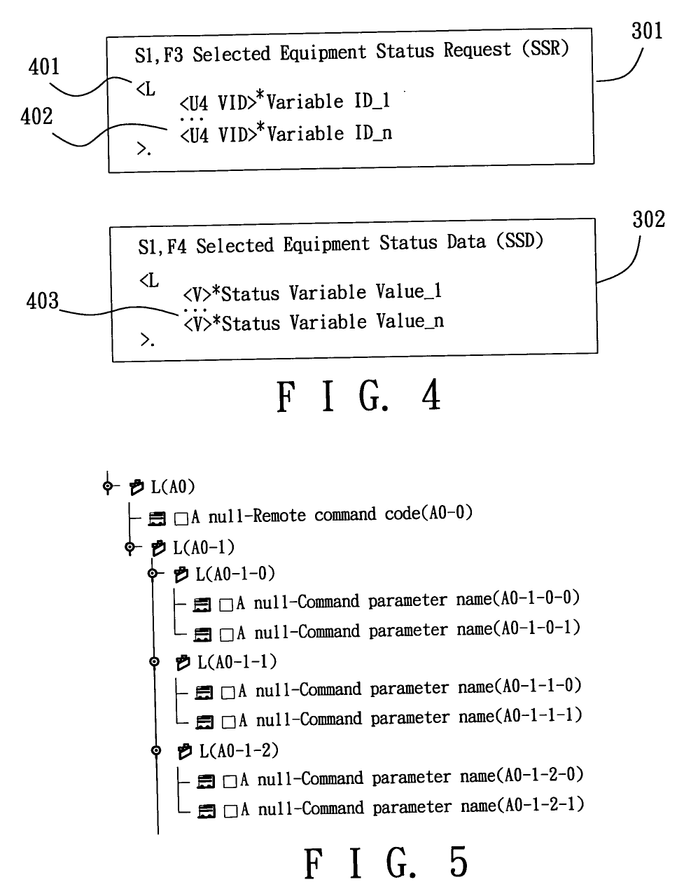

In step 503, the coding module 532 codes each of the SECS items of the SECS messages. In this embodiment, the SECS items of each of the SECS messages are coded with an attribute tags. When one of the SECS items includes a set of SECS sub-items, the attribute tag for said one of the SECS items that includes the set of SECS sub-items includes a primary tag portion and a set of secondary tag portions corresponding respectively to the SECS sub-items. For example, one of the SECS messages is parsed into n SECS items, which are coded with the attribute tags, such as A0-An-1. Furthermore, the n^{th} SECS item coded with An-1 includes i SECS sub-items, which are coded with An-1.0-An-1.i-1, respectively. FIG. 4 illustrates an example of SECS messages 301, 302. In this example, the SECS message 301 includes a SECS item 401, and lists of items 402 (i.e., n SECS sub-items) that are content described between angle brackets following S1F3. The SECS message 302 includes a SECS item, such as S1F4, and lists of items 403 (i.e., n SECS sub-items) that are content described between angle brackets following S1F4. In view of the SECS message 301, when the SECS item 401 is coded with A0 according to the above coding example, for example, <U4 VID>*Variable ID_{—}4 (i.e., one of n SECS sub-items) is coded with A0.3 according to the above coding example. Referring to FIG. 5, another example of a coded SECS message is shown to have a multi-level architecture.

In step 504, the mapping module 533 determines which ones of the coded SECS items of the SECS messages from the tool control unit 6 correspond to preset items of interest. For example, when all SECS sub-items 402 of the SECS item 401 coded with A0 of the SECS message 301 in FIG. 4 correspond to the preset items of interest, the SECS items 401 can be coded in step 502 as A0.*.

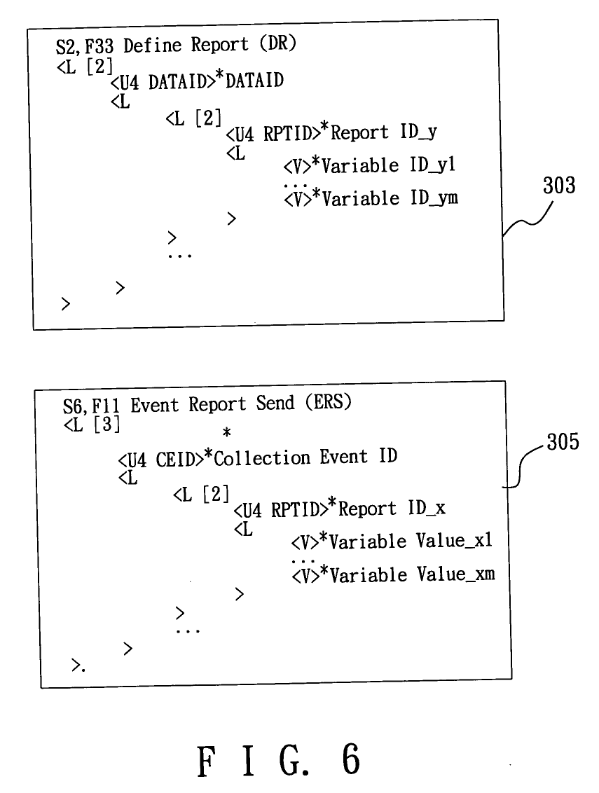

In step 506, the mapping module 533 determines which ones of the SECS messages from the semiconductor equipments 7 have a dependency with any one of the coded SECS items determined in step 504. For example, in FIG. 4, when <V>*Status Variable Value_n of S1F4 has the dependency with <U4 VID>*Variable ID_n of S1F3, the SECS item S1F3 can be denoted as A0.@, where “@” means that the SECS sub-item coded with A0.n of the SECS item S1F4 has the dependency with the SECS sub-item coded with A0.n of the SECS item S1F3. In another example shown in FIG. 6, when <U4 RPTID>*Report ID_x of the SECS item S6F11 of the SECS message 305 corresponds to <U4 RPTID>*Report ID_y of the SECS item S2F33 of the SECS message 303 (i.e., both have the same Report ID), <V>*Variable Value_xm of the SECS item S6F11 of the SECS message 305 has a dependency with <U4 VID>*Variable ID_ym of the SECS item S2F33 of the SECS message 303. As such, when A0.2.*.0 of the SECS item S6F11 is equal to A0.1.*.0 of the SECS item S2F33, the dependency can be denoted such that S6F11:A0.2.*.1.* depends on S2F33:A0.0.*. @.

In step 508, the mapping module 533 pairs the coded SECS items determined in step 506 with the coded SECS items determined in step 504 according to the dependency thereof.

In step 509, the translating module 534 converts the paired coded SECS items obtained in step 508 into the XML messages.

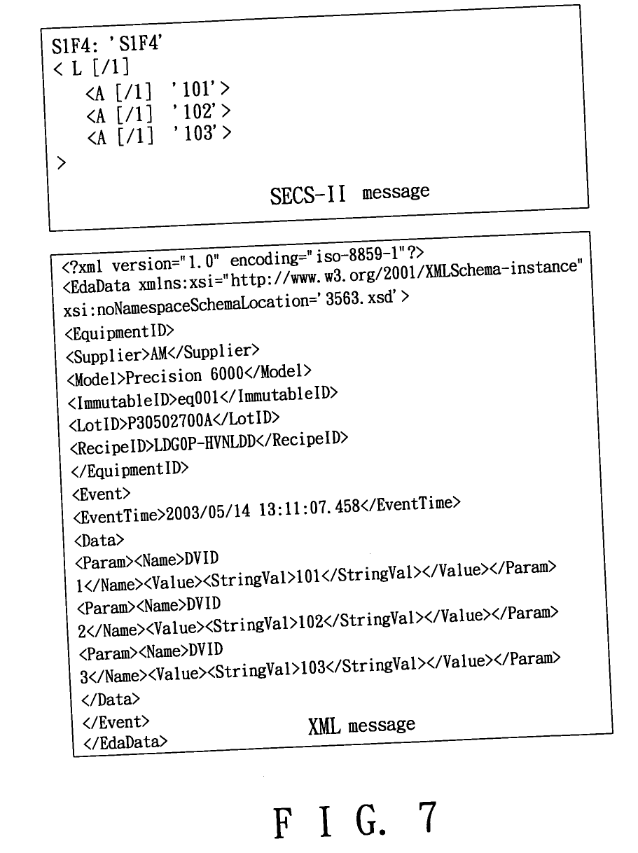

FIG. 7 illustrates an example of converting a SECS message into an XML message, where S1F4 means selected equipment status data.

It is noted that a monitor 50 is coupled to the converting unit 53 (see FIG. 2), and generates a display window to provide a visual indication of the XML messages so as to facilitate monitoring of the operating status of the semiconductor equipment system by an operator.

To sum up, the XML messages converted from the SECS messages according to the method of the present invention are more easily comprehended by operators as compared to the SECS messages, and facilitates subsequent information-exchanging processing using non-proprietary software.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method of monitoring message transactions in a semiconductor equipment system, comprising the steps of:
a) converting SECS messages, which are in a semiconductor equipment communications standard (SECS) language, transacted in the semiconductor equipment system into XML messages, which are in an extensible markup language (XML); and
b) generating a display window for visual indication of the XML messages.

2. The method as claimed in claim 1, wherein step a) includes the sub-steps of:
a-1) parsing each of the SECS messages into a set of SECS items;
a-2) coding each of the SECS items of the SECS messages;
a-3) determining which ones of the coded SECS items of the SECS messages from a tool control unit of the semiconductor equipment system correspond to preset items of interest;
a-4) determining which ones of the coded SECS items of the SECS messages from a semiconductor equipment of the semiconductor equipment system have a dependency with any one of the coded SECS items determined in sub-step a-3);
a-5) pairing the coded SECS items determined in sub-step a-4) with the coded SECS items determined in sub-step a-3) according to the dependency thereof; and
a-6) converting the paired coded SECS items obtained in sub-step a-5) into the XML messages.

3. The method as claimed in claim 2, wherein the SECS items of each of the SECS messages are coded with an attribute tag in sub-step a-2).

4. The method as claimed in claim 3, wherein one of the SECS items includes a set of SECS sub-items, said attribute tag for said one of the SECS items that includes the set of SECS sub-items including a primary tag portion and a set of secondary tag portions corresponding respectively to the SECS sub-items.

5. The method as claimed in claim 3, wherein sub-steps a-3), a-4) and a-5) are conducted by mapping the coded SECS items of the SECS messages according to the attribute tags.

6. A method of converting SECS messages transacted between a tool control unit and a semiconductor equipment in a semiconductor equipment system into XML messages, each of the SECS messages being in a semiconductor equipment communications standard (SECS) language, the XML messages being in an extensible markup language (XML), said method comprising the steps of:
a) parsing each of the SECS messages into a set of SECS items;
b) coding each of the SECS items of the SECS messages;
c) determining which ones of the coded SECS items of the SECS messages from the tool control unit correspond to preset items of interest;
d) determining which ones of the coded SECS items of the SECS messages from the semiconductor equipment have a dependency with any one of the coded SECS items determined in step c);
e) pairing the coded SECS items determined in step d) with the coded SECS items determined in step c) according to the dependency thereof; and
f) converting the paired coded SECS items obtained in step e) into the XML messages.

7. The method as claimed in claim 6, wherein the SECS items of each of the SECS messages are coded with an attribute tag in step b).

8. The method as claimed in claim 7, wherein one of the SECS items includes a set of SECS sub-items, said attribute tag for said one of the SECS items that includes the set of SECS sub-items including a primary tag portion and a set of secondary tag portions corresponding respectively to the SECS sub-items.

9. The method as claimed in claim 7, wherein steps c), d) and e) are conducted by mapping the coded SECS items of the SECS messages according to the attribute tags.

10. An apparatus for monitoring message transactions in a semiconductor equipment system, comprising:
converting means for converting SECS messages, which are in a semiconductor equipment communications standard (SECS) language, transacted in the semiconductor equipment system into XML messages, which are in an extensible markup language (XML); and
display generating means, coupled to said converting means, for generating a display window to provide a visual indication of the XML messages.

11. The apparatus as claimed in claim 10, wherein said converting means includes:
a parsing module for parsing each of the SECS messages into a set of SECS items;
a coding module for coding each of the SECS items of the SECS messages;
a mapping module for mapping the SECS items of the SECS messages coded by said coding module; and
a translating module for translating the coded SECS items mapped by said mapping module into the XML messages.

12. An apparatus for converting SECS messages transacted between a tool control unit and a semiconductor equipment in a semiconductor equipment system into XML messages, each of the SECS messages being in a semiconductor equipment communications standard (SECS) language, the XML messages being in an extensible markup language (XML), said apparatus comprising:
an interface processing unit adapted to be coupled to the tool control unit and the semiconductor equipment for receiving the SECS messages therefrom;
a register coupled to said interface processing unit for storing the SECS messages from the semiconductor equipment and the tool control unit and transmitted via said interface processing unit; and
a converting unit coupled to said register and including
a parsing module for parsing each of the SECS messages stored in said register into a set of SECS items,
a coding module for coding each of the SECS items of the SECS messages,
a mapping module for mapping the SECS items of the SECS messages coded by said coding module, and
a translating module for translating the coded SECS items mapped by said mapping module into the XML messages.

13. The apparatus as claimed in claim 12, wherein said interface processing unit includes at least one of an RS232 and a TCP/IP interface.

14. A computer program product for configuring an apparatus to perform steps of a method of converting SECS messages transacted between a tool control unit and a semiconductor equipment in a semiconductor equipment system into XML messages, each of the SECS messages being in a semiconductor equipment communications standard (SECS) language, the XML messages being in an extensible markup language (XML) the apparatus including an interface processing unit coupled to the tool control unit and the semiconductor equipment for receiving the SECS messages therefrom, a register coupled to the interface processing unit for storing the SECS messages from the tool control unit and the semiconductor equipment and transmitted via the interface processing unit, and a converting unit coupled to the register, said computer program product comprising:
a computer readable storage medium comprising:
a first code that directs the converting unit to parse each of the SECS messages into a set of SECS items;
a second code that directs the converting unit to code each of the SECS items of the SECS messages;
a third code that directs the converting unit to determine which ones of the coded SECS items of the SECS messages from the tool control unit correspond to preset items of interest;
a fourth code that directs the converting unit to determine which ones of the coded SECS items of the SECS messages from the semiconductor equipment have a dependency with any one of the coded SECS items corresponding to the preset items of interest;
a fifth code that directs the converting unit to pair the coded SECS items of the SECS messages according to the dependency thereof; and
a sixth code that directs the converting unit to convert the paired coded SECS items into the XML messages.
